(19) United States
(12) Patent Application Publication
(10) Pub. No.: US 2017/0076679 A1
(43) Pub. Date: Mar. 16, 2017

(54) DISPLAY DEVICE

(71) Applicant: InnoLux Corporation, Miao-Li County (TW)

(72) Inventors: Yao-Jen OU, Miao-Li County (TW); Chao-Lung CHIN, Miao-Li County (TW); Hsu-Kuan HSU, Miao-Li County (TW)

(21) Appl. No.: 15/260,611

(22) Filed: Sep. 9, 2016

(30) Foreign Application Priority Data
Sep. 11, 2015 (CN) 201510577700.1

(51) Int. Cl. G09G 3/36; G09G 5/18

(52) U.S. Cl. CPC G09G 3/3614; G09G 5/18; G09G 3/3674; G09G 2230/00; G09G 2320/0247

(57) ABSTRACT

A display device is provided. A driver provides at least a scan signal according to a vertical synchronization signal and provides at least a positive data signal and at least a negative data signal according to a horizontal synchronization signal. A pixel of a display panel receives the positive or negative data signal. The vertical synchronization signal has three successive rising edges to determine the first frame period including a first disable period and a second frame period including a second disable period. The first and second frame periods determine the cycle. In the cycle, the pixel receives the positive data signal during a first receiving and holding period, and receives the negative data signal during a second receiving and holding period. The first or second receiving and holding period is not equal to half of the sum of the first and second disable periods.

### CROSS REFERENCE TO RELATED APPLICATIONS

This Application claims priority of China Patent Application No. 201510577700.1, filed on Sep. 11, 2015, the entirety of which is incorporated by reference herein.

### BACKGROUND OF THE INVENTION

Field of the Invention

The invention relates to an electronic device, and more particularly to a display device.

Description of the Related Art

Liquid-crystal display devices are used widely because they possess such favorable advantages as having a thin profile, light weigh, and low radiation. Generally, it needs to alternately provide a positive voltage and a negative voltage to the liquid-crystal layer of a liquid-crystal display device due to the properties of the liquid-crystal component of the liquid-crystal layer. The conventional method is to provide a common voltage to compensate for the difference between the positive voltage and the negative voltage provided to the liquid crystal. However, if the common voltage is shifted, flickering may occur on the display device, thereby lowering the reliability of the display device and quickly deteriorating the display device.

### BRIEF SUMMARY OF THE INVENTION

In accordance with an embodiment, a display device comprises a timing controller, a driver, and a display panel. The timing controller provides a horizontal synchronization signal and a vertical synchronization signal. The driver provides at least a scan signal according to the vertical synchronization signal and provides at least a positive data signal or at least a negative data signal according to the horizontal synchronization signal. The positive data signal relative to a common voltage has a positive polarity. The negative data signal relative to the common voltage has a negative polarity. The display panel comprises at least a pixel to receive the positive data signal or the negative data signal. The vertical synchronization signal has a first rising edge, a second rising edge, and a third rising edge. The first, second, and third rising edges are successive. A first frame period is determined according to the first and second rising edges. The first frame period comprises a first disable period. A second frame period is determined according to the second and third rising edges. The second frame period comprises a second disable period. A first cycle is determined according to the first frame period and the second frame period. In the first cycle, the pixel receives the positive data signal during a first receiving and holding period and receives the negative data signal during a second receiving and holding period. The first receiving and holding period or the second receiving and holding period is not equal to half of the sum of the first disable period and the second disable period.

In accordance with another embodiment, the display device comprises a timing controller and a driver. The timing controller provides a horizontal synchronization signal and a vertical synchronization signal. The vertical synchronization signal has a first rising edge and a second rising edge. The first rising edge and the second rising edge are successive. A first frame period is determined according to the first rising edge and second rising edge. The first frame period comprises a first disable period. The driver provides at least a scan signal according to the vertical synchronization signal and provides a plurality of positive data signals and a plurality of negative data signals according to the horizontal synchronization signal in the first frame period. The positive data signal relative to a common voltage has a positive polarity. The negative data signal relative to the common voltage has a negative polarity. The sum of durations of the positive data signals output by the driver is not equal to half of the first disable period.

In accordance with a further embodiment, a control method of controlling a display device comprises providing a vertical synchronization signal and a horizontal synchronization signal; providing at least a scan signal according to the vertical synchronization signal and providing at least a positive data signal or at least a negative data signal to a pixel according to the horizontal synchronization signal, wherein the positive data signal relative to a common voltage has a positive polarity, and the negative data signal relative to the common voltage has a negative polarity, wherein the vertical synchronization signal has a first rising edge, a second rising edge, and a third rising edge, the first, second, and third rising edges are successive, wherein a first frame period is determined according to the first and second rising edges, the first frame period comprises a first disable period, a second frame period is determined according to the second and third rising edges, and the second frame period comprises a second disable period, wherein a first cycle is determined according to the first frame period and second frame period, in the first cycle, the pixel receives the positive data signal during a first receiving and holding period, and the pixel receives the negative data signal during a second receiving and holding period, wherein the first receiving and holding period or the second receiving and holding period is not equal to half of the sum of the first disable period and second disable period.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a display device, according to various aspects of the present disclosure.

FIGS. 2A and 2B are schematic diagrams of exemplary embodiments of the signals, according to various aspects of the present disclosure;

FIG. 3 is a schematic diagram of another exemplary embodiment of the signals, according to various aspects of the present disclosure;

FIG. 4 is a schematic diagram of another exemplary embodiment of the signals, according to various aspects of the present disclosure;

FIG. 5 is a schematic diagram of another exemplary embodiment of the signals, according to various aspects of the present disclosure;

FIG. 6 is a schematic diagram of another exemplary embodiment of the signals, according to various aspects of the present disclosure; and

FIG. 7 is a flowchart of an exemplary embodiment of a control method, according to various aspects of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

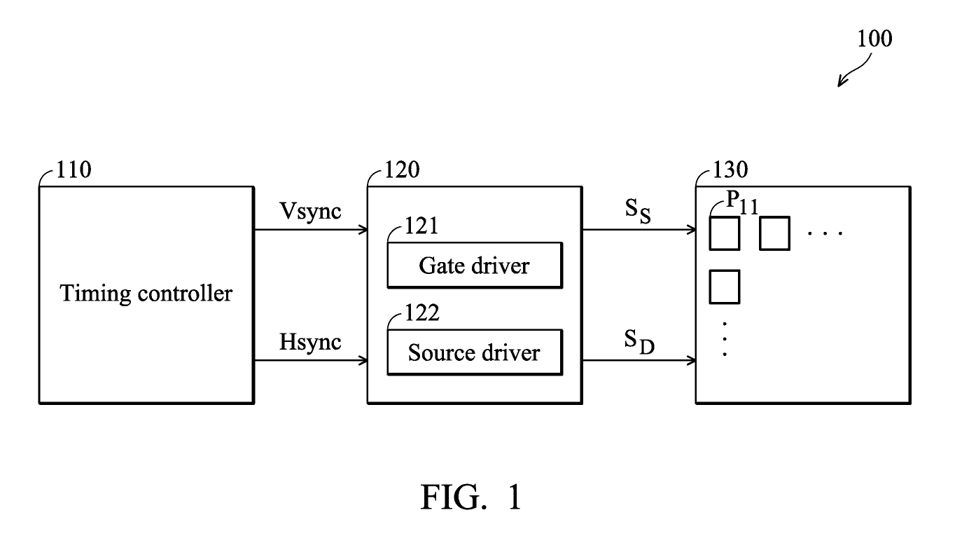

FIG. 1 is a schematic diagram of an exemplary embodiment of a display device, according to various aspects of the present disclosure. The display device 100 comprises a timing controller (TCON) 110, a driver 120 and a display panel 130. The invention does not limit the kind of display device 100. In one embodiment, the display device 100 is a personal digital assistant (PDA), a cellular phone, a digital camera, a television, a global positioning system (GPS), a car display, an avionics display, a digital photo frame, a notebook computer (NB), or a personal computer (PC).

The timing controller 110 generates a vertical synchronization signal Vsync and a horizontal synchronization signal Hsync to activate the driver 120. The driver 120 provides at least a scan signal S_{S} to the display panel 130 according to the vertical synchronization signal Vsync. The driver 120 further provides at least a data signal S_{D} to the display panel 130 according to the horizontal synchronization signal Hsync. The data signal S_{D} could be a positive data signal with a positive polarity relative to a common voltage or a negative data signal with a negative polarity relative to the common voltage. For example, when the voltage level of the data signal S_{D} is higher than the voltage level of the common voltage, the data signal S_{D} is a positive data signal. On the contrary, when the voltage level of the data signal S_{D} is lower than the voltage level of the common voltage, the data signal S_{D} is a negative data signal.

In one embodiment, the driver 120 comprises a gate driver 121 and a source driver 122. The gate driver 121 generates a scan signal S_{S} according to the vertical synchronization signal Vsync to enable the scan lines (not shown) of the display panel 130. The source driver 122 generates data signal S_{D} according to the horizontal synchronization signal Hsync to the data lines (not shown) of the display panel 130.

The display panel 130 comprises at least a pixel. For brevity, the pixel P₁₁ is given as an example. The pixel P₁₁ has a liquid-crystal component and displays the corresponding brightness according to the scan signal S_{S} and the data signal S_{D}. The invention does not limit the kind of display panel 130. In one embodiment, the display panel 130 is a Fringe Field Switching (FFS) panel or a In-Plane Switching panel or an OLED panel. The invention does not limit the arrangement of the pixels in the display panel 130. In one embodiment, the pixels in the display panel 130 are arranged according to a matrix form or a delta form.

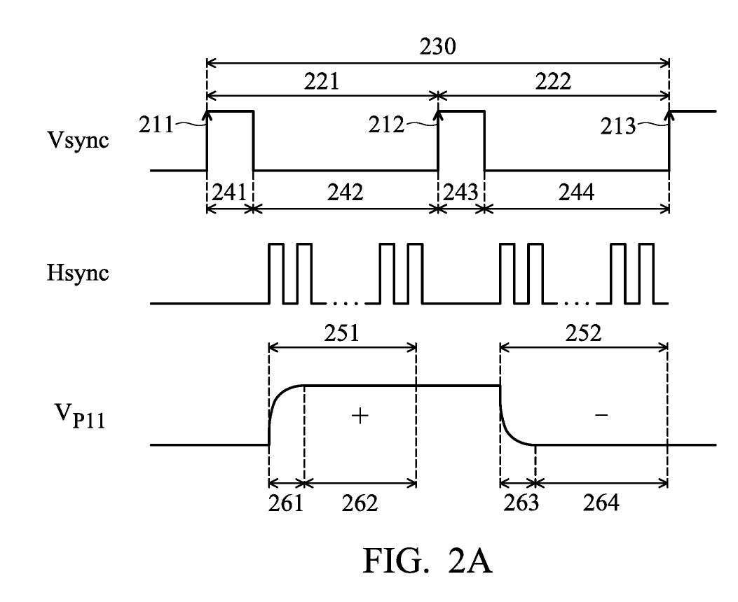

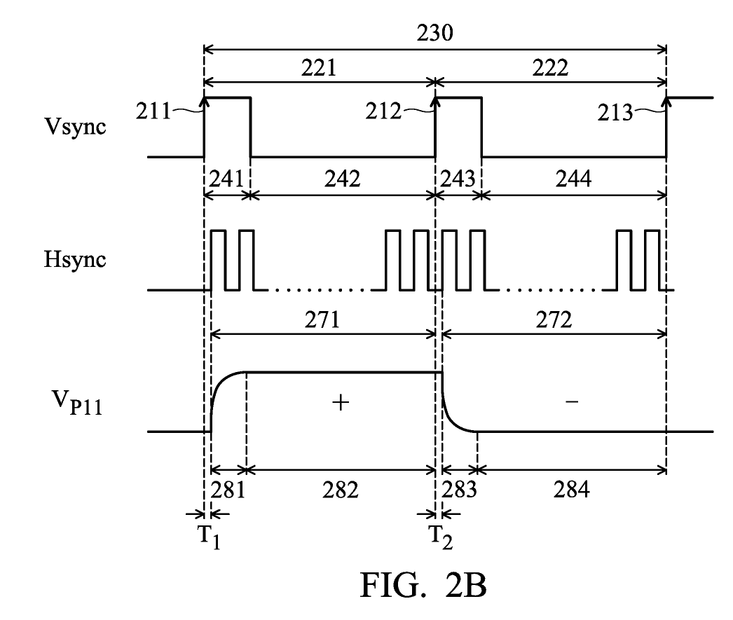

FIG. 2A and FIG. 2B are schematic diagrams of exemplary embodiments of the signals, according to various aspects of the present disclosure. In one embodiment, the vertical synchronization signal Vsync comprises a plurality of rising edges. For brevity, FIG. 2A only shows the rising edges 211˜213, however, the invention is not limited to this number of rising edges. In other embodiments, the vertical synchronization signal Vsync has more rising edges or fewer rising edges. Two neighbor rising edges determines a frame period. For example, a frame period 221 is determined according to the rising edges 211 and 212, and a frame period 222 is determined according to the rising edges 212 and 213, in another words, a frame period is defined as a period between the adjacent two rising edges in this embodiment.

The frame period 221 comprises an enable period 241 and a disable period 242. The frame period 222 comprises an enable period 243 and a disable period 244. In the enable periods 241 and 243, the vertical synchronization signal Vsync is at a high level. In the disable periods 242 and 244, the vertical synchronization signal Vsync is at a low level. In this embodiment, the disable period 242 is equal to the disable period 244, but the disclosure is not limited thereto. In other embodiments, the enable period 241 is not equal to the enable period 243, or the disable period 242 is not equal to the disable period 244. The enable period is shorter than the disable period. In another embodiment, the duration of the enable period could be zero or approaches zero.

A cycle 230 is determined according to the frame periods 221 and 222. In one embodiment, each cycle comprises at least two neighbor frame periods. In other embodiments, each cycle comprises a plurality of frame periods and the number of frame periods is even. Additionally, the frame periods included in a cycle do not overlap the frame periods included in a neighbor cycle. For example, the cycle 230 is determined according to the neighbor frame periods 221 and 222, and the next cycle does not comprise the frame period 222.

In each frame period, the horizontal synchronization signal Hsync comprises a plurality of pulses to activate the driver such that the driver generates data signals. Furthermore, the symbol V_{P11} represents the state change of the pixel P₁₁ when the pixel P₁₁ receives a data signal. As shown in FIG. 2A, the timing controller 110 generates the horizontal synchronization signal Hsync after the enable period 241. The timing controller 110 stops generating the horizontal synchronization signal Hsync during the enable period 243. Therefore, the pixel P₁₁ receives and stores a positive data signal during the receiving and holding period 251. Similar, the pixel P₁₁ receives and stores a negative data signal during the receiving and holding period 252. In the cycle 230, the receiving and holding period 251 or 252 is respectively not equal to half of the sum of the disable periods 242 and 244. In another embodiment, the receiving and holding period 251 is not equal to the receiving and holding period 252.

FIG. 2B is similar to FIG. 2A exception that the timing controller 110 generates the horizontal synchronization signal Hsync during the frame periods 221 and 222. For example, the level of the vertical synchronization signal Vsync is changed from a low level to a high level at the time T₁. In this case, timing controller 110 starts to generate the horizontal synchronization signal Hsync after the time T₁. In this embodiment, timing controller 110 generates the horizontal synchronization signal Hsync at the time T₂, but the disclosure is not limited thereto. The pixel P₁₁ receives and stores a positive data signal during the receiving and holding period 271 and receives and stores a negative data signal during the receiving and holding period 272. In this embodiment, the receiving and holding period 271 is longer than the receiving and holding period 251, and the receiving and holding period 272 is longer than the receiving and holding period 252. In the cycle 230, the receiving and holding period 271 or 272 is respectively not equal to half of the sum of the disable periods 242 and 244. In another embodiment, the receiving and holding period 271 is not equal to the receiving and holding period 272.

Please refer to FIG. 2A and FIG. 2B, the receiving and holding period 251 (271) comprises a charging period 261 (281) and a stable period 262 (282). The receiving and holding period 252 (272) comprises a charging period 263 (283) and a stable period 264 (284). In the charging periods 261 (281) and 263 (283), the pixel P₁₁ is charged according to the type of the data signal. For example, when the pixel P₁₁ receives a data signal with a positive polarity, the pixel P₁₁ is charged to a positive voltage level. In one embodiment, the charging period 261 (281) is defined as when the voltage level of the pixel Pᵤ starts to level up to 0.9 H (H is the highest voltage level received by the pixel P11 in the frame period 221), and the stable period 262 (282) is defined as a period from a time point of an end of the charging period 261 (281) to a time point of the end of the frame period 221. When the pixel P₁₁ receives a data signal with a negative polarity, the pixel P₁₁ is charged to a negative voltage level. In one embodiment, the charging period 263 (283) is defined as when the voltage level of the pixel P₁₁ starts to level down to 0.9 L (L is the lowest voltage received by the pixel P₁₁ in the frame period 222). The voltage level of the pixel P₁₁ is maintained in the stable periods 262 (282) and 264 (284). The stable period could be defined as the time from the end time point of the charging period 261 (263,281,283) to the end time point of the frame period 221 (222), and the stable period 264 (284) is defined as a period from a time point of an end of the charging period 263 (283) to a time point of the end of the frame period 222. In one embodiment, the stable period 262 (282) is not equal to the stable period 264 (284).

Since the polarity of the data signal S_{D} is determined according to the relation between the voltage levels of the data signal S_{D} and a common voltage. Therefore, when the voltage level of the common voltage is shifted, the difference between the voltage levels of the data signal S_{D} and the common voltage is changed. However, in the embodiment, the receiving and holding period (e.g. 251) when the pixel P₁₁ receives and stores the positive data signal is not equal to the receiving and holding period (e.g. 252) when the pixel P₁₁ receives and stores the negative data signal in each cycle. The affection caused by shifted common voltage is compensated.

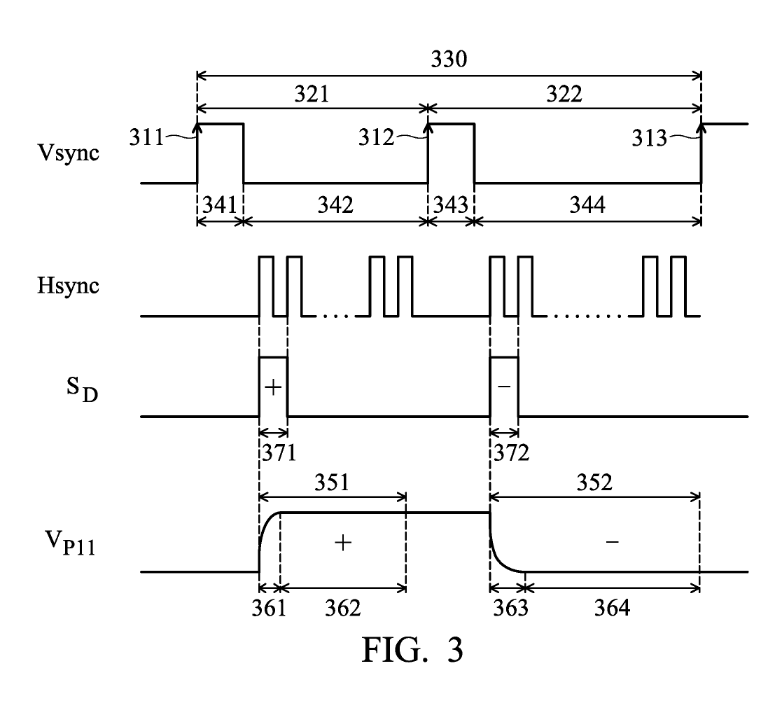

FIG. 3 is a schematic diagram of another exemplary embodiment of the signals, according to various aspects of the present disclosure. The frame period 321 is determined according to the rising edges 311 and 312. The frame period 322 is determined according to the rising edges 312 and 313. The cycle 330 is determined according to the frame periods 321 and 322. In one embodiment, the frame period 321 is not equal to half of the cycle 330. In other words, the frame period 321 is not equal to the frame period 322. In this embodiment, the disable period 342 of the frame period 321 is not equal to the disable period 344 of the frame period 322.

In the period 371, the driver provides a positive data signal to the pixel P₁₁. In the period 372, the driver provides a negative data signal to the pixel P₁₁. The duration of the period 371 is equal to the duration of the period 372. In the receiving and holding period 351, the pixel P₁₁ receives and holds the positive data signal. In the receiving and holding period 352, the pixel P₁₁ receives and holds the negative data signal. Since the duration of the disable period 342 is not equal to the duration of the disable period 344, the duration of the receiving and holding period 351 is not equal to the duration of the receiving and holding period 352. In one embodiment, the stable period 362 of the receiving and holding period 351 is not equal to the stable period 364 of the receiving and holding period 352.

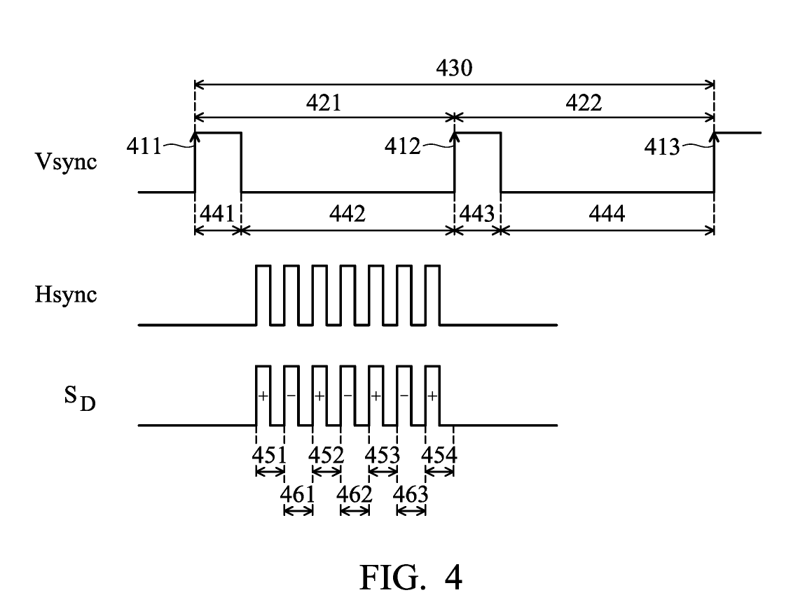

FIG. 4 is a schematic diagram of another exemplary embodiment of the signals, according to various aspects of the present disclosure. The frame period 421 is determined according to the rising edges 411 and 412. The frame period 422 is determined according to the rising edges 412 and 413. The cycle 430 is determined according to the frame periods 421 and 422. In this embodiment, the frame period 421 is substantially equal to the frame period 422. In one embodiment, the enable period 441 is equal to the enable period 443. The disable period 442 is equal to the disable period 444.

The driver outputs a plurality of positive data signals and a plurality of negative data signals in each frame period. The total duration of the driver outputting the positive data signals is not equal to the total duration of the driver outputting the negative data signals in a frame period. For example, the driver outputs the positive data signals in the periods 451˜454 of the frame period 421 and outputs the negative data signals in the periods 461˜463 of the frame period 421. The total duration of the periods 451˜454 is not equal to half of the disable period 442. In another embodiment, the total of the periods 451˜454 is not equal to the total of the periods 461˜463. In some embodiments, the number of positive data signals provided by the driver is not equal to the number of negative data signals provided by the driver in the frame period 421.

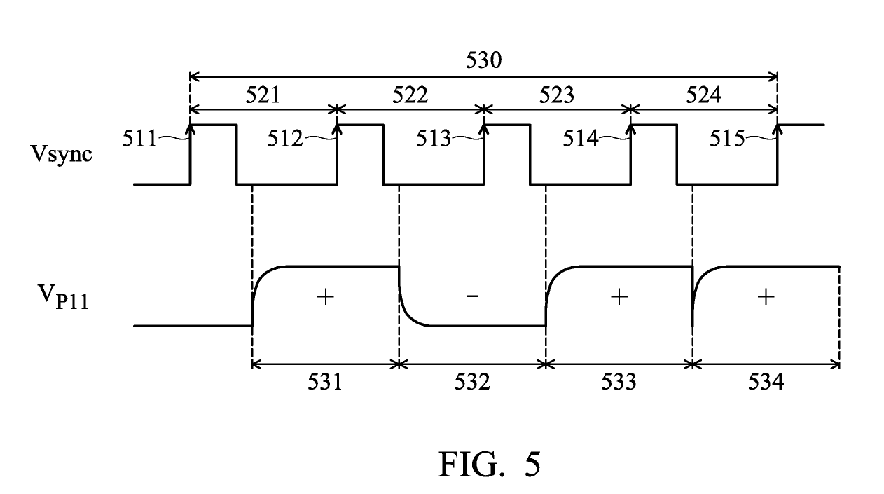

FIG. 5 is a schematic diagram of another exemplary embodiment of the signals, according to various aspects of the present disclosure. For brevity, the cycle 530 shown in FIG. 5 only comprises the frame periods 521˜524, but the number of frame periods is not limited to thereto. In some embodiments, the cycle 530 comprises more frame periods or fewer frame periods. In this embodiment, the durations of the frame periods 521˜524 are the same.

In the receiving and holding periods 531˜534, the pixel P₁₁ receives data signals. The duration of the receiving and holding periods 531˜534 are the same. In the receiving and holding periods 531, 533, and 534, the pixel P₁₁ receives the positive data signals. In the receiving and holding period 532, the pixel P₁₁ receives the negative data signal. In the cycle 530, the number of positive data signals received by the pixel P₁₁ is different from the number of negative data signals received by the pixel P₁₁ to compensate for the effects of the shifted common voltage.

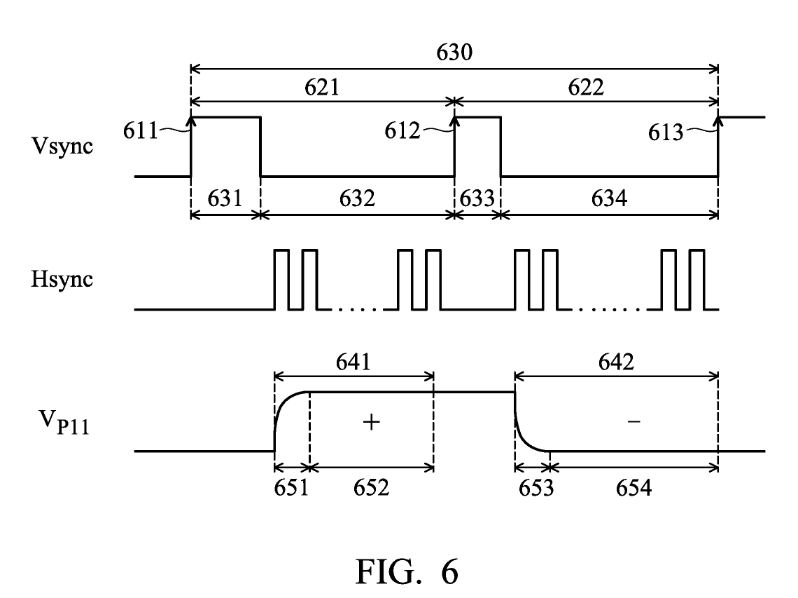

FIG. 6 is a schematic diagram of another exemplary embodiment of the signals, according to various aspects of the present disclosure. The cycle 630 comprises the frame periods 621 and 622. The frame period 621 comprises an enable period 631 and a disable period 632. The frame period 622 comprises an enable period 633 and a disable period 634. In this embodiment, the frame period 621 is equal to the frame period 622, but the enable period 631 is not equal to the enable period 633. In this case, the disable period 632 is also not equal to the disable period 634.

During the receiving and holding period 641, the pixel P₁₁ receives the positive data signals. During the receiving and holding period 642, the pixel P₁₁ receives the negative data signals. The duration of the receiving and holding period 641 is not equal to the duration of the receiving and holding period 642. Additionally, the receiving and holding period 641 comprises a charging period 651 and a stable period 652. The receiving and holding period 642 comprises a charging period 653 and a stable period 654. In this embodiment, the duration of the stable period 652 is not equal to the duration of the stable period 654.

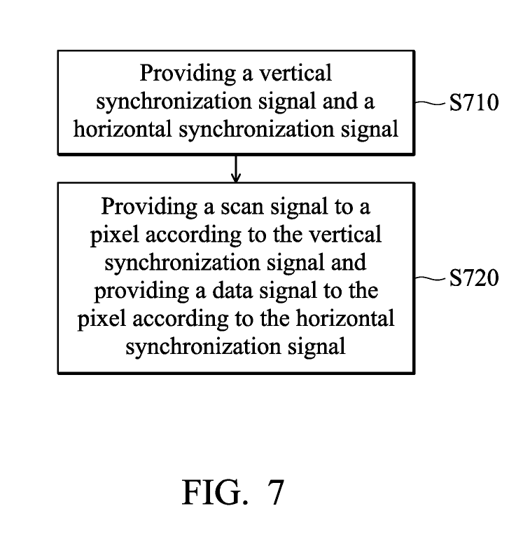

FIG. 7 is a flowchart of an exemplary embodiment of a control method, according to various aspects of the present disclosure. The control method an embodiment of the invention controls a liquid-crystal display device. First, a vertical synchronization signal and a horizontal synchronization signal are provided (step S710). In one embodiment, a timing controller (TCON) is utilized to provide a vertical synchronization signal and a horizontal synchronization signal. In this embodiment, the vertical synchronization signal has successive rising edges.

Taking three successive rising edges as an example, a first frame period is determined according to a first rising edge and a second rising edge. A second frame period is determined according to the second rising edge and a third rising edge. In one embodiment, the duration of the first frame period is not equal to the duration of the second frame period. Furthermore, the first frame period comprises a first enable period and a first disable period. The second frame period comprises a second enable period and a second disable period. In the first enable period and the second enable period, the vertical synchronization signal is at a high level. In the first and second disable period, the vertical synchronization signal is at a low level. The duration of the first disable period may be equal to or not equal to the duration of the second disable period. Similar, the duration of the first enable period may be equal to or not equal to the duration of the second enable period.

Next, a scan signal is provided to a specific pixel according to the vertical synchronization signal and a data signal is provided to the specific pixel according to the horizontal synchronization signal (step S720). When the data signal relative to a common voltage has a positive polarity, the data signal is referred to as a positive data signal. Conversely, when the data signal relative to the common voltage has a negative polarity, the data signal is referred to as a negative data signal.

In one embodiment, the data signal is provided by a driver. The driver outputs a plurality of positive data signals and a plurality of negative data signals in each frame period according to the horizontal synchronization signal. The sum of the duration of the driver outputting the positive data signals in each frame period is not equal to half of the corresponding disable period. In other embodiments, the number of positive data signals provided by the driver is different from the number of negative data signals provided by the driver in each frame period.

A cycle is determined according to a plurality of frame periods. The specific pixel receives the positive data signal in a first disable period of the cycle and holds the positive data signal in a first receiving and holding period. The specific pixel receives the negative data signal in a second disable period of the cycle and holds the negative data signal in a second receiving and holding period. In this embodiment, the first receiving and holding period or the second receiving and holding period is respectively not equal to half of the sum of the first disable period and the second disable period. In one embodiment, the first receiving and holding period is not equal to the second receiving and holding period. In other embodiments, the specific pixel receives the positive data signal or the negative data signal in different periods. In successive periods, the number of times (e.g. 51) that the specific pixel receives the positive data signal is different from the number of times (e.g. 49) that the specific pixel receives the negative data signal, wherein the number of successive periods is a specific number (e.g. 100), and the positive data signal and the negative data signal could be alternately provided to the specific pixel.

The first receiving and holding period has a first charging period and a first stable period. In the first charging period, the specific pixel receives the positive data signal and charges to a positive level according to the positive data signal. In the first stable period, the level of the specific pixel is maintained at the positive level. Similarly, the second receiving and holding period has a second charging period and a second stable period. In the second charging period, the specific pixel receives the negative data signal and charges to a negative level according to the negative data signal. In the second stable period, the level of the specific pixel is maintained at the negative level. In one embodiment, the first stable period is not equal to the second stable period.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a timing controller providing a horizontal synchronization signal and a vertical synchronization signal;
a driver providing at least a scan signal according to the vertical synchronization signal and providing at least a positive data signal or at least a negative data signal according to the horizontal synchronization signal, wherein the positive data signal relative to a common voltage has a positive polarity, and the negative data signal relative to the common voltage has a negative polarity; and
a display panel comprising at least a pixel to receive the positive data signal or the negative data signal;
wherein the vertical synchronization signal has a first rising edge, a second rising edge, and a third rising edge, and the first, second, and third rising edges are successive,
wherein a first frame period is determined according to the first and second rising edges, the first frame period comprises a first disable period, a second frame period is determined according to the second and third rising edges, and the second frame period comprises a second disable period,
wherein a first cycle is determined according to the first frame period and the second frame period, and in the first cycle, the pixel receives the positive data signal during a first receiving and holding period, and the pixel receives the negative data signal during a second receiving and holding period, and
wherein the first receiving and holding period or the second receiving and holding period is not equal to half of a sum of the first disable period and the second disable period.

2. The display device as claimed in claim 1, wherein the first receiving and holding period is not equal to the second receiving and holding period.

3. The display device as claimed in claim 1, wherein the first receiving and holding period has a first charging period and a first stable period, the second receiving and holding period has a second charging period and a second stable period, and the first stable period is not equal to the second stable period.

4. The display device as claimed in claim 1, wherein the first disable period is not equal to the second disable period.

5. The display device as claimed in claim 1, wherein the vertical synchronization signal has several rising edges, a period is determined according the first rising edge and a (2N+1)th rising edge, N is an integer and larger than 1, in the period, the number of positive data signals received by the pixel is different from the number of negative data signals received by the pixel.

6. A display device comprising:
a timing controller providing a horizontal synchronization signal and a vertical synchronization signal, wherein the vertical synchronization signal has a first rising edge and a second rising edge, the first rising edge and the second rising edge are successive, a first frame period is determined according to the first and second rising edges, and the first frame period comprises a first disable period; and
a driver providing at least a scan signal according to the vertical synchronization signal and providing a plurality of positive data signals and a plurality of negative data signals according to the horizontal synchronization signal in the first frame period, wherein the positive data signal relative to a common voltage has a positive polarity, and the negative data signal relative to the common voltage has a negative polarity;
wherein a sum of the durations of the positive data signals output by the driver is not equal to half of the first disable period.

7. The display device as claimed in claim 6, wherein in the first frame period, number of positive data signals is not equal to number of negative data signals.

8. The display device as claimed in claim 6, wherein in the first frame period, a sum of the durations of the positive data signals provided by driver is not equal to a sum of the durations of the negative data signals provided by the driver.

9. A control method controlling a display device and comprising:
providing a vertical synchronization signal and a horizontal synchronization signal;
providing at least a scan signal according to the vertical synchronization signal and providing at least a positive data signal or at least a negative data signal to a pixel according to the horizontal synchronization signal, wherein the positive data signal relative to a common voltage has a positive polarity, and the negative data signal relative to the common voltage has a negative polarity,
wherein the vertical synchronization signal has a first rising edge, a second rising edge, and a third rising edge, and the first, second, and third rising edges are successive,
wherein a first frame period is determined according to the first and second rising edges, the first frame period comprises a first disable period, a second frame period is determined according to the second and third rising edges, and the second frame period comprises a second disable period,
wherein a first cycle is determined according to the first frame period and the second frame period, and in the first cycle, the pixel receives the positive data signal during a first receiving and holding period, and the pixel receives the negative data signal during a second receiving and holding period, and
wherein the first receiving and holding period or the second receiving and holding period is not equal to half of a sum of the first disable period and the second disable period.

10. The control method as claimed in claim 9, wherein the first receiving and holding period is not equal to the second receiving and holding period.

11. The control method as claimed in claim 9, wherein the first disable period is not equal to the second disable period.
